(19) United States
(12) Patent Application Publication
(10) Pub. No.: US 2007/0193666 A1
(43) Pub. Date: Aug. 23, 2007

(54) High Strength Dual Phase Steel With Low Yield Ratio, High Toughness and Superior Weldability

(75) Inventors: Hitoshi Asahi, Futtsu-shi (JP); Takuya Hara, Futtsu-shi (JP); Yoshio Terada, Kimitsu-shi (JP); Masaaki Sugiyama, Futtsu-shi (JP); Narasimha-Rao V. Bangaru, Pittstown, NJ (US); Ja-Young Koo, Somerset, NJ (US); Hyun-Woo Jin, Easton, PA (US); Adnan Ozekcin, Bethlehem, PA (US); Douglas P. Fairchild, Sugar Land, TX (US)

Correspondence Address: BAKER BOTTS, LLP, 910 LOUISIANA, HOUSTON, TX, 77002-4995, US

(73) Assignee: ExxonMobil Upstream Research Company

(21) Appl. No.: 11/684,915

(22) Filed: Mar. 12, 2007

Related U.S. Application Data
(63) Continuation of application No. PCT/US06/60030, filed on Oct. 17, 2006.
(60) Provisional application No. 60/729,577, filed on Oct. 24, 2005.

(51) Int. Cl. C22C 38/08

(52) U.S. Cl. 148/654; 148/336; 420/119

(57) ABSTRACT

A dual phase, high strength steel having a composite microstructure of soft and hard phases providing a low yield ratio, high strain capacity, superior weldability, and high toughness is provided. The dual phase steel includes from about 10% by volume to about 60% by volume of a first phase or constituent consisting essentially of fine-grained ferrite. The first phase has a ferrite mean grain size of about 5 microns or less. The dual phase steel further includes from about 40% by volume to about 90% by volume of a second phase or constituent comprising fine-grained martensite, fine-grained lower bainite, fine-grained granular bainite, fine-grained degenerate upper bainite, or any mixture thereof. Methods for making the same are also provided.

### CROSS-REFERENCE TO RELATED APPLICATIONS

This application is a continuation of and claims priority to International Application No. PCT/US06/60030, filed Oct. 17, 2006; and U.S. Provisional Application Ser. No. 60/729,577, filed Oct. 24, 2005; wherein both applications are hereby incorporated by reference herein for all purposes.

### BACKGROUND OF THE INVENTION

1. Field of the Invention

Embodiments of the present invention generally relate to high strength, dual phase steel and methods for making the same.

2. Description of the Related Art

Natural gas is becoming an increasingly important energy source. Often the major natural gas fields in the world are far removed from the major markets, some thousands of miles apart. Improving the long distance gas transportation economics plays a critical role in deciding whether a particular remote gas field development will be economic or not. Higher strength linepipe are seen as a key to improving the oil and gas transportation economics. Significant advantages of using higher strength linepipe in constructing long distance pipelines include transportation efficiency by increasing internal pressure, and material cost savings through reduction of pipe wall thickness as well as concomitant savings during the field welding of thinner wall pipe. Reduced transportation costs associated with transporting the lighter linepipes can provide additional savings.

Currently the highest yield strength linepipe in commercial use exhibits a minimum yield strength of about 550 MPa (80 Ksi, designated as API grade X80). Higher strength linepipe grades such as API X100 (100 Ksi yield strength) and X120 have recently been developed. As disclosed in U.S. Pat. Nos. 6,248,191; 6,224,689; 6,288,183; and 6,264,760 it has been found practical to produce high strength steels having yield strengths greater than 827 MPa (120 Ksi) and with ultimate tensile strengths greater than about 900 MPa (130 Ksi) as precursors to linepipe. Those patents further disclose steel microstructures having predominantly fine-grained lower bainite, fine-grained lath martensite, or mixtures thereof and thermo-mechanical controlled rolling processes (TMCP) to produce those microstructures. While those microstructures provide high strength and consequently offer high performance for stress-based pipeline designs, those microstructures are not optimal for strain-based pipeline designs due to the high yield to tensile ratios and limited work hardening potential in the precursor steel plate.

Certain pipelines require a strain-based design philosophy because the pipeline will experience significant service strain. For example, high imposed strains can take place in seismically active regions and/or arctic regions that are subject to frost-heave and thaw settlement cycles. In these regions, significant strains can be imposed on the pipeline requiring high strain capacity in the linepipe. A low yield to tensile strength ratio and high uniform elongation in the precursor steel plate are indicative of high work hardening or strain hardening capability and high strain capacity in the steel plate as well as the linepipe fabricated from this plate.

FIG. 1 shows a schematic stress strain curve 100 for an illustrative precursor steel plate according to embodiments described compared to a stress strain curve 110 of an illustrative steel characterized by a predominantly lath martensitic/bainitic microstructure (i.e. “state of the art steel”). The point where the stress-strain curve deviates from linearity as the stress is increased indicates yielding or the onset of permanent or plastic deformation in the steel. The maximum stress that can be sustained by the steel before this deviation sets in can be defined as the yield strength. On the other hand, tensile strength or ultimate tensile strength is the maximum stress sustained by the steel including the permanent or plastic deformation regime. The strain or percent elongation at the point of this maximum in stress or tensile strength is known as the uniform elongation 120. The strain hardening or work hardening characteristics define the stress-strain curve between the yield and tensile strength. It can be seen that the state-of-the-art steels and dual phase steels of the present invention provide similar tensile strengths but dramatically different yield strengths and strain hardening response. The state-of-the-art steels strain harden rapidly and reach their tensile strength at lower strains resulting in lower uniform elongation. On the other hand, dual phase steels of the present invention based on a composite microstructure of soft and hard phases will provide a lower yield strength and a gradual strain hardening and a high strain capacity as schematically depicted with a higher uniform elongation 130 in these steels.

There is a need, therefore, for high strength steels with a low yield to tensile strength ratio, substantially uniform microstructure, superior work hardening capability, and excellent weldability. There is also a need for a low cost method for manufacturing linepipes with excellent low temperature toughness and excellent strain capacity suitable for strain-based designs.

### SUMMARY OF THE INVENTION

Dual phase, high strength steel having a composite microstructure of soft and hard phases providing a low yield ratio, high strain capacity, superior weldability, and high toughness is provided as well as methods for making the same. For example, a high strength, dual phase steel with a tensile strength of about 900 MPa or more, a low yield ratio of about 0.85 or less in a longitudinal direction, and a Charpy-V-Notch toughness at −40° C. exceeding about 120 J or more in the transverse direction is provided. In at least one specific embodiment, the dual phase steel comprises:
carbon in an amount from about 0.03% by weight to about 0.12 wt %;
nickel in an amount of about 0.1 wt % to less than 1.0 wt %;
niobium in an amount of about 0.005 wt % to about 0.05 wt %;
titanium in an amount of about 0.005 wt % to about 0.03 wt %;
molybdenum in an amount of about 0.1 wt % to about 0.6 wt %; and
manganese in an amount of about 0.5 wt % to about 2.5 wt %;
   In other embodiments, the steel comprises the following optional elements, by weight:
up to about 0.1% vanadium;
up to about 0.010% nitrogen;
up to about 0.002% boron;
up to about 0.006% magnesium;
up to about 1.0% chromium;
up to about 0.5% silicon;
up to about 1.0% copper;
up to about 0.06% aluminum;
up to about 0.015% phosphorus; and
up to about 0.004% sulfur.

The dual phase steel can also include a first phase or constituent consisting essentially of fine-grained ferrite. The steel can include from about 10% by volume to about 60% by volume of the first phase, and the first phase includes a ferrite mean grain size of about 5 microns or less. The dual phase steel further includes a second phase or constituent comprising fine-grained martensite, fine-grained lower bainite, fine-grained granular bainite, fine-grained degenerate upper bainite, or any mixture thereof, wherein the steel comprises from about 40% by volume to about 90% by volume of the second constituent.

A method for preparing a steel plate with a tensile strength of about 900 MPa or more, a low yield ratio of about 0.85 or less in a longitudinal direction, and a Charpy-V-Notch toughness at −40° C. exceeding about 120 J or more in the transverse direction is also provided. In at least one specific embodiment, the method includes heating a steel slab to a reheating temperature from about 1,000° C. to about 1,250° C. to provide a steel slab consisting essentially of an austenite phase. The steel slab is reduced to form the steel plate in one or more hot rolling passes at a first temperature sufficient to recrystallize the austenite phase. The steel plate is reduced in one or more hot rolling passes at a second temperature range below the first temperature at a temperature where austenite does not recrystallize and above Ar3 transformation temperature. The steel plate is cooled in ambient air to a temperature above about 500° C., and then quenched at a cooling rate of at least 10° C. per second (18° F./sec) to a pre-selected quench stop temperature.

A steel plate with a tensile strength of about 900 MPa or more, a low yield ratio of about 0.85 or less in a longitudinal direction, and a Charpy-V-Notch toughness at −40° C. exceeding about 120 J or more in the transverse direction, comprising from about 10% by volume to about 60% by volume of a first phase/constituent consisting essentially of fine grained ferrite, from about 40% by volume to about 90% by volume of a second phase/constituent comprising fine-grained martensite, fine-grained lower bainite, fine-grained granular bainite, fine-grained degenerate upper bainite, or any mixture thereof is also provided. The steel plate can be produced by heating a steel slab to a reheating temperature from about 1,000° C. to about 1,250° C. to provide a steel slab consisting essentially of an austinite phase. The steel slab is reduced to form the steel plate in one or more hot rolling passes at a first temperature sufficient to recrystallize the austenite phase. The steel plate is reduced in one or more hot rolling passes at a second temperature range below the first temperature where the austenite does not recrystallize and above Ar3 transformation temperature. The steel plate is further reduced in one or more hot rolling passes at a third temperature range between about the Ar3 transformation temperature and about Ar1 transformation temperature. The steel plate is then quenched at a cooling rate of at least 10° C. per second (18° F./sec) to a pre-selected quench stop temperature.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic stress-strain curve illustrating the excellent strain hardening and strain capacity in dual phase steels as described versus predominantly bainitic/martensitic steels.

FIG. 2 is a set of schematic diagrams illustrating the formation of ferrite domains in austenite pancakes during the slow cooling (e.g., air cooling) through the inter-critical region and the development of dual phase microstructure of ferrite-lath martensite/DUB/LB during subsequent accelerated cooling to ambient.

FIGS. 3A and 3B show images revealing an illustrative composite microstructure in steel processed according to embodiments described. FIG. 3(A) is an SEM micrograph showing a fine dispersion of an illustrative dual phase microstructure comprising a ferrite phase and a second phase produced according to the embodiments described. FIG. 3B is a TEM micrograph showing the fine ferrite domain size (˜1 micron) of the ferrite phase shown in FIG. 3A.

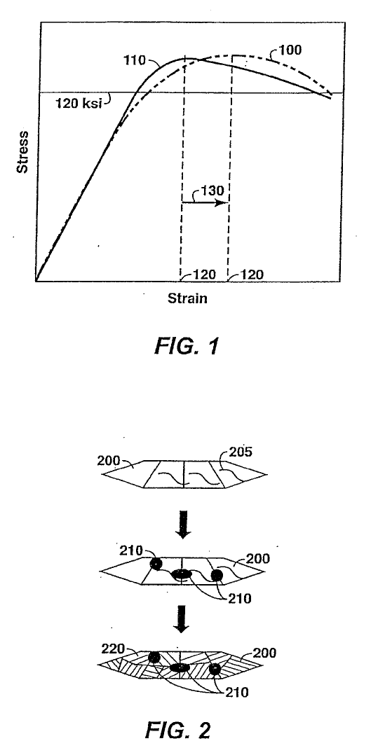

### DETAILED DESCRIPTION OF PREFERRED EMBODIMENTS

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. The invention will now be described in greater detail below, including specific embodiments, versions and examples, but the inventions are not limited to these embodiments, versions or examples, which are included to enable a person having ordinary skill in the art to make and use the inventions, when the information in this patent is combined with available information and technology.

A high strength, dual phase steel with a low yield-to-tensile ratio, high uniform elongation, and high work hardening coefficient and methods for making the same are provided. The steel has a high strain capacity and good formability. Such steel is suitable for linepipe, offshore structures, oil and gas production facilities, and pressure vessels, for examples.

Microstructure

In one or more embodiments, the steel has a microstructure that includes from about 10 percent by volume to about 60 percent by volume of a softer, fine grained ferrite phase or constituent (“first phase”) and from about 40 percent by volume to about 90 percent by volume of a stronger phase or constituent (“second phase”) that can include one or more phases or constituents of: fine grained martensite, fine grained lower bainite, fine grained degenerate upper bainite, fine grained granular bainite, and mixtures thereof.

As used herein, the term “fine grained” refers to grains within each of the microstructure constituent or domain having an average grain size of about 10 microns or less, such as about 5 microns or less, about 4 microns or less, about 3 microns or less, and about 2 microns or less.

Ar1 transformation temperature refers to the temperature at which transformation of austenite to ferrite or to ferrite plus cementite is completed during cooling.

Ar3 transformation temperature refers to the temperature at which austenite begins to transform to ferrite during cooling.

Cooling rate refers to the rate of cooling at the center, or substantially at the center, of the plate thickness.

Deformed ferrite (DF) refers to ferrite that forms from austenite decomposition during inter-critical exposure and undergoes deformation due to hot rolling subsequent to its formation;

Dual phase means at least two phases.

Fine granular bainite (FGB) is an aggregate comprising about 60 percent by volume (vol %) of bainitic ferrite to about 95 vol % of bainitic ferrite and up to about 5 vol % to about 40 vol % dispersed particles of mixtures of lath martensite and retained austenite.

Grain is an individual crystal in a polycrystalline material.

Grain boundary refers to a narrow zone in a metal corresponding to the transition from one crystallographic orientation to another, thus separating one grain from another.

Prior austenite grain size refers to an average austenite grain size in a hot-rolled steel plate prior to rolling in the temperature range in which austenite does not recrystallize.

Quenching refers to accelerated cooling by any means whereby a fluid selected for its tendency to increase the cooling rate of the steel is utilized, as opposed to air cooling.

Quench Stop Temperature (QST) is the highest, or substantially the highest, temperature reached at the surface of the plate, after quenching is stopped, because of heat transmitted from the mid-thickness of the plate.

A slab is a piece of steel having any dimensions.

Tnr temperature is the temperature below which austenite does not recrystallize.

Transverse direction refers to a direction that is in the plane of rolling but perpendicular to the plate rolling direction.

Steel Composition

In one or more embodiments, the steel includes iron and one or more various alloying elements. Preferably, the steel is formulated to have a tensile strength exceeding about 900 MPa; yield to tensile strength (YTS) ratio or yield ratio (YR) of about 0.90, preferably less than about 0.85, even more preferably less than about 0.8; and high toughness, exceeding about 120 J in Charpy-V-Notch test at −40° C., preferably exceeding about 150 J in Charpy-V-Notch test at −40° C. Suitable alloying elements can include, but are not limited to carbon, manganese, silicon, niobium, titanium, aluminum, molybdenum, chromium, nickel, copper, vanadium, boron, nitrogen, and combinations thereof, for example. Certain alloying elements and preferred ranges are described in further detail below.

For example, carbon is one of the most potent strengthening elements in steel. Carbon combines with the strong carbide formers in the steel such as Ti, niobium and V to provide grain growth inhibition and precipitation strengthening. Carbon also enhances hardenability, i.e., the ability to form harder and stronger microstructures in the steel during cooling, such as lath martensite, lower bainite, and degenerate upper bainites, etc. If the carbon content is less than about 0.03 wt %, it is generally not sufficient to induce the necessary strengthening in a low alloy steel, i.e., strength greater than about 750 MPa (˜110 Ksi) tensile strength, in the steel. If the carbon content is greater than about 0.12 wt %, the steel can be susceptible to cold cracking during welding and the toughness can be reduced in the steel plate as well as the HAZ on welding. Carbon content in the range of about 0.03 wt % to about 0.12 wt % is preferred to produce the desired combination of high strength and toughness in the plate, HAZ and to avoid cold cracking during welding.

In one or more embodiments above or elsewhere herein, the steel can include manganese (Mn). Manganese can be a matrix strengthener in steels and more importantly, can contribute to hardenability. Manganese is an inexpensive alloying addition to prevent excessive ferrite formation in thick section plates especially at mid-thickness locations of these plates which can lead to a reduction in plate strength. A minimum amount of 0.5 wt % manganese is preferred for achieving the desired high strength in plate thicknesses exceeding 12 mm, and a minimum of 1.0 wt % is even more preferred. Manganese, through its strong effect in delaying ferrite, granular bainite and upper bainite transformation products of austenite during its cooling, provides processing flexibility for producing the desired ferrite-strong second phase microstructure (lath martensite, lower bainite and degenerate upper bainite) being designed in this invention. However, too much manganese is harmful to steel plate toughness, so an upper limit of about 2.5 wt % manganese is preferred. This upper limit is also preferred to substantially minimize centerline segregation that tends to occur in high manganese and continuously cast steel slabs and the attendant poor microstructure and toughness properties in the center of the plate produced from the slab. More preferably, the upper limit for manganese is 2.0.

In one or more embodiments above or elsewhere herein, the steel can include silicon (Si). Silicon can be added for de-oxidation purposes and a minimum of about 0.01 wt % is preferred for this purpose. Aluminum is also used for de-oxidation and therefore, high silicon amounts are not required for this purpose. Silicon is a strong matrix strengthener, but it has a strong detrimental effect on both base steel and HAZ toughness. Therefore, an upper limit of 0.5 wt % is placed on silicon. Silicon increases the driving force for carbon migration into the untransformed austenite during the cool down (quenching) of the steel plate from high temperature and in this sense reduces the interstitial content of ferrite and improves its flow and ductility. This beneficial effect of silicon should be balanced with its intrinsic effect on degrading the toughness of the steel. Due to these balancing forces, an optimum silicon addition in the alloys of this invention is between about 0.05 to 0.15 wt %.

In one or more embodiments above or elsewhere herein, the steel can include niobium (Nb). Niobium can be added to promote grain refinement during hot rolling of the steel slab into plate which in turn improves both the strength and toughness of the steel plate. Niobium carbide precipitation during hot rolling serves to retard recrystalization and to inhibit grain growth, thereby providing a means of austenite grain refinement. For these reasons, at least 0.005 wt % niobium is needed. Niobium is also strong hardenability enhancer and provides precipitation strengthening in the HAZ through formation of niobium carbides or carbonitrides. These effects of niobium addition to steel are useful to minimize HAZ softening, particularly next to the fusion line, in high strength steel weldments. For this reason a minimum of 0.01 wt % niobium is more preferred in steel plates subjected to welding during fabrication into useful objects such as linepipe. However, higher niobium can lead to excessive precipitation strengthening and consequently, degrade toughness in both the base steel and especially in the HAZ. For these reasons, an upper limit of 0.05 wt % is placed on niobium for steels of this invention. Even more preferably, the niobium content in the steels of this invention are in the range from about 0.01 wt % to about 0.04 wt %.

In one or more embodiments above or elsewhere herein, the steel can include titanium (Ti). Titanium is effective in forming fine titanium nitride (TiN) precipitates which refine the grain size in both the rolled structure and the HAZ of the steel. Thus, the toughness of the steel and HAZ are improved. A minimum of 0.005 wt % titanium is needed for this purpose. Titanium is added to the steel in such an amount that the weight ratio of Ti/N is preferably about 3.4. Excessive titanium additions to the steel tend to deteriorate the toughness of the steel by forming coarse TiN particles or titanium carbide particles. Thus, the upper limit for titanium is set at 0.03 wt %.

In one or more embodiments above or elsewhere herein, the steel can include aluminum (Al). Aluminum can be added primarily for deoxidation of the steel. At least 0.01 wt % aluminum is preferred for this purpose. Small amounts of aluminum in the steel are also beneficial for HAZ properties by tying up free nitrogen that comes about from dissolution of nitride and carbonitride particles in the coarse grain HAZ due to the intense thermal cycles of the welding process. However, aluminum is similar to silicon in reducing the deformation and toughness properties of the matrix. In addition, higher aluminum additions lead to excessive, coarse aluminum-oxide inclusions in the steel which degrade toughness. Hence, an upper limit of 0.06 wt % is set for aluminum additions in the steels of this invention.

In one or more embodiments above or elsewhere herein, the steel can include molybdenum (Mo). Molybdenum can increase the hardenability of the steel especially in combination with boron and niobium. Molybdenum also increases the strength of the ferrite matrix. Thus, molybdenum additions provide strengthening in the base steel. Molybdenum additions in the current steel also provide flexibility for processing to allow an optimum combination of ferrite-strong second phases that in turn produce high strength and toughness. Molybdenum additions also strengthen the weld HAZ through precipitation of molybdenum carbides. For these reasons, at least 0.1 wt % and more preferably 0.2 wt % of molybdenum are added to the steels of the present invention. Excessive molybdenum additions results in high cold cracking susceptibility of the steel during welding and also tends to deteriorate the toughness of the steel and HAZ. Therefore, an upper limit of 0.6 wt % and more preferably, an upper limit of 0.5 wt % molybdenum is set for the steels of this invention.

In one or more embodiments above or elsewhere herein, the steel can include chromium (Cr). Chromium can have a strong effect on increasing the hardenability of the steel upon direct quenching. Thus, chromium is a cheaper alloying addition than molybdenum for improving hardenability and controlling excessive ferrite formation in the steels of present invention, especially in steels without added boron. Chromium improves the corrosion resistance and hydrogen induced cracking resistance (HIC). Similar to molybdenum, excessive chromium tends to cause cold cracking in weldments, and tends to deteriorate the toughness of the steel and its HAZ, so when chromium is added a maximum of 1.0 wt % is preferred.

In one or more embodiments above or elsewhere herein, the steel can include nickel (Ni). Nickel can enhance the toughness of the base steel as well as the HAZ. A minimum of 0.1 wt % nickel and more preferably, a minimum of 0.3 wt % nickel is needed to produce significant beneficial effect on the HAZ and base steel toughness. Although not to the same degree as manganese and molybdenum additions, nickel addition to the steel promotes hardenability and, therefore, through thickness uniformity in microstructure and properties in thick sections (20 mm and higher). However, excessive nickel additions can impair field weldability (causing cold cracking), can reduce HAZ toughness by promoting hard microstructures, and can increase the cost of the steel. For these reasons, the upper limit of nickel should be about 1.0 wt %, preferably less than 1.0 wt %, and more preferably less than 0.9 wt %. Nickel addition is also effective for the prevention of copper-induced surface cracking during continuous casting and hot rolling. Nickel added for this purpose is preferably greater than about ⅓ of the copper content.

In one or more embodiments above or elsewhere herein, the steel can include copper (Cu). Copper can contribute to strengthening of the steel via increasing the hardenability and through potent precipitation strengthening via ε-copper precipitates. At higher amounts, copper induces excessive precipitation hardening and if not properly controlled, can lower the toughness in the base steel plate as well as in the HAZ. Higher copper can also cause embrittlement during slab casting and hot rolling, requiring co-additions of nickel for mitigation. For these reasons, when copper is added, an upper limit of 1.0 wt % is preferred.

In one or more embodiments above or elsewhere herein, the steel can include vanadium (V). Vanadium has substantially similar, but not as strong of an effect as niobium. However, the addition of vanadium produces a remarkable effect when added in combination with niobium. The combined effect of vanadium and niobium greatly minimizes HAZ softening during high heat input welding such as seam welding in linepipe manufacture. Like niobium, excessive vanadium can degrade toughness of both the base steel as well as the HAZ through excessive precipitation hardening. Preferably, less than about 0.1 wt % or more preferably less than about 0.065 wt % of vanadium can be added.

In one or more embodiments above or elsewhere herein, the steel can include boron (B). Boron can greatly increase the hardenability of steel very inexpensively and promote the formation of steel microstructures of lower bainite, lath martensite even in thick sections (>16 mm). Boron allows the design of steels with overall low alloying and Pcm (weldability parameter Pcm=wt % C+wt % Si/30+(wt % Mn+wt % Cu+wt % Cr)/20+wt % Ni/60+wt % Mo/15+wt % V/10+5×wt % B) and thereby improve HAZ softening resistance and weldability. Boron additions suppress formation of ferrite, granular bainite, and upper bainite phases. While the suppression of the latter two provides improved toughness, the suppression of ferrite requires the balancing of the other alloying elements with the processing methods to compensate for the negative effect of boron on ferrite formation. The microstructure of the current invention requires a critical volume fraction of soft, fine-grained ferrite phase. Boron in excess of about 0.002 wt % can promote the formation of embrittling particles of Fe23(C,B)6. Therefore, when boron is added, an upper limit of 0.002 wt % boron is preferred. Boron also augments the hardenability effect of molybdenum and niobium.

In one or more embodiments above or elsewhere herein, the steel can include nitrogen (N). Nitrogen can inhibit coarsening of austenite grains during slab reheating and in the HAZ by forming TiN precipitates and thereby enhancing the low temperature toughness of base metal and HAZ. If nitrogen is added for this effect, a minimum of 0.0015 wt % nitrogen is needed. However, too much nitrogen addition may lead to excessive free nitrogen in the HAZ and degrade HAZ toughness. For this reason, the upper limit for nitrogen is preferably set at 0.010 wt %, or more preferably at 0.006 wt %.

In one or more embodiments above or elsewhere herein, the steel can include magnesium (Mg). Magnesium generally forms finely dispersed oxide particles, which can suppress coarsening of the grains and/or promote the formation of intra-granular ferrite in the HAZ and, thereby, improve HAZ toughness. At least about 0.0001 wt % Mg is desirable for the addition of magnesium to be effective. However, if the magnesium content exceeds about 0.006 wt %, coarse oxides are formed and the toughness of the HAZ is deteriorated. Therefore, if magnesium is added, an upper limit of 0.006 wt % is preferred.

Preferably, residuals are minimized. For example, sulfur (S) content is preferably less than about 0.004 wt %. Phosphorus (P) content is preferably less than about 0.015 wt %.

Method for Making

In one or more embodiments, the compositions described are produced in a manner to obtain a fine dispersion of ferrite such that the mean effective domain size is less than about 5 microns and preferably less than about 2 microns. FIG. 2 is a set of schematic diagrams illustrating the formation of ferrite domains in austenite pancakes. The pancake 200 is slow cooled (e.g., air cooling) through the inter-critical region to provide one or more ferrite domains 210. The pancake 200 is then subjected to accelerated cooling to ambient to develop a dual phase microstructure of ferrite-lath martensite/DUB/LB 220. As shown, a very fine dispersion of ferrite phase 210 is formed from the austenite 205 which then remains in the final steel microstructure.

Domain size as used herein refers to microstructural units that are separated by crystal orientation differences of at least 10° and these units are important in controlling cleavage fracture resistance. Finer domains promote better cleavage fracture resistance. With a fine ferrite dispersion, both yield strength and low temperature toughness can be excellent at given overall tensile strength of the composite microstructure wherein the tensile strength is mainly dependent on the volume fractions of soft ferrite phase and strong phases.

In one or more embodiments, the compositions described are produced in a manner such that the amount of ferrite (total of fresh and deformed ferrite) is at least 20 volume percent, more preferably at least 25 volume percent and even more preferably at least 30 volume percent of the steel. Preferably, the ferrite is uniformly dispersed throughout the steel and the ferrite mean grain size of the steel is not more than about 5 microns (μm). Preferably, the ferrite mean grain size of the steel is less than about 4 microns, preferably less than about 3 microns and even more preferably less than about 2 microns.

In one or more embodiments above or elsewhere herein, the compositions described are produced in a manner such that the effective prior austenite grain size (i.e. “pancake thickness”) is less than about 10 μm. The effective prior austenite grain size is the average thickness or width of austenite pancakes that are developed at the end of hot rolling measured along the thickness direction of the plate upon completion of the cooling of the plate to the ambient temperature.

For example, the steel can be made using a two step rolling process. In one or more embodiments, a steel billet/slab can be formed in normal fashion such as through a continuous casting process. The billet/slab can then be re-heated to a temperature within the range of about 1000° to about 1,250° C. Preferably, the reheating temperature is sufficiently high enough to (i) substantially homogenize the steel slab, (ii) dissolve substantially all the carbide and carbonitrides of niobium and vanadium, when present, in the steel slab, and (iii) establish fine initial austenite grains in the steel slab. The re-heated slab is then hot rolled in one or more passes in a first reduction providing about 30% to about 70% reduction at a first temperature range where austenite recrystallizes. Next, the reduced billet is hot rolled in one or more passes in a second rolling reduction providing about 40-80% reduction in the second and somewhat lower temperature range wherein austenite does not recrystallize but above the Ar3 transformation point. Preferably, the cumulative rolling reduction below the Tnr temperature is at least 50%, more preferably at least about 70%, even more preferably at least 75%.

For this two step rolling process, the second rolling reduction is completed at a temperature sufficient to produce steel within a single phase austenite region so that no ferrite or essentially no ferrite is formed at the end of hot rolling. The finish rolling temperature for this process is above 760° C., preferably above 780° C. Thereafter, the hot rolled plate is cooled (e.g. in air) to a temperature at or above about 500° C. to induce austenite to ferrite transformation followed by an accelerated cool at a rate of at least about 10° C. per second to a quench stop temperature of about 400° C. to about room temperature where no further transformation to ferrite can occur. If the accelerated cooling stop temperature is other than room temperature, the steel plate can be further cooled to room temperature using air, for example, from the accelerated cooling stop temperature. This processing is abbreviated as “DLQ” processing.

In one or more embodiments above or elsewhere herein, the steel can be made using a three step rolling process. For example, the steel can be prepared by forming a steel billet/slab in normal fashion such as through a continuous casting process. The slab is reheated to a temperature within the range of 1000° to 1250° C. and rolled in one or more passes in a first reduction providing about 30% to about 70% reduction at a first temperature range where austenite recrystallizes. The reduced slab is then rolled in one or more passes in a second rolling reduction providing about 40% to about 80% reduction in a second and somewhat lower temperature range when austenite does not recrystallize but above the Ar3. The slab is cooled, using air for example, to a temperature in the range between the Ar3 and Ar1 and rolled in one or more passes in a third rolling reduction of about 15% to about 25% where about 10% to about 60% of the austenite has transformed to ferrite. Thereafter, the steel is accelerated cooled (e.g. water cooled) at a rate of at least 10° C. per second, preferably at least about 20° C. per second (i.e. “accelerated cooling”) from the finish rolling temperature to a temperature less than about 400° C., where no further transformation to ferrite can occur. If desired, the rolled, high strength steel plate can be cooled to room temperature at the end of this accelerated cooling stop temperature using air for example. This process is abbreviated as “DPP” processing.

In one or more embodiments above or elsewhere herein, the steel can be made using a three step rolling process that utilizes a delayed quench (DLQ) step to promote the kinetics of ferrite transformation. This process is especially useful for boron-containing steels. In one or more embodiments, the steel can be slow cooled in ambient air to allow the austenite to transform to ferrite following the third rolling reduction step, as described above in the DPP processing. The lowest temperature at which this ambient air cooling step (i.e. “delay quench”) is terminated is called the “DLQ” temperature. In one or more embodiments, the DLQ temperature can range from about 500° C. to about 700° C. In one or more embodiments, the DLQ temperature can range from about 500° C. to about 600° C. Thereafter, the cooling of the plate is accelerated by quenching (e.g. water cooling) at a rate of at least 10° C. per second, preferably about 20° C. per second to about 35° C. per second, to a pre-selected quench stop temperature. In one or more embodiments, the pre-selected quench stop temperature is between about 400° C. and about room temperature. In one or more embodiments, the pre-selected quench stop temperature is about 390° C., or about 380° C., about 370° C., about 360° C., or about 350° C., or about 300° C., or about 250° C., or about 200° C., or about 150° C., or about 100° C., or about 50° C. This process is a hybrid between the DPP processing and the DLQ processing described and hence designated as “DPP+DLQ.”

Not wishing to be bound by theory, it is believed that the quenching step stops the austenite-to-ferrite transformation and thus, sets the final mix of microstructure constituents. The remaining austenite then transforms to granular bainite (GB), upper bainite (UB), degenerate upper bainite (DUB), lower bainite (LB), lath martensite (LM) or mixtures thereof. All these phases are stronger than ferrite and thus a stronger composite microstructure is developed.

Some residual austenite may be retained, however, in the final microstructure in the form of films mostly at the boundaries of lath structures such as DUB and LM. Moreover, the steel can include some deformed ferrite (e.g. ferrite that undergoes deformation due to the rolling after its formation). The deformed ferrite can increase the yield strength without significantly impairing toughness of the overall composite microstructure. Thus, the physical properties of the microstructure can be improved due to the presence of deformed ferrite. In one or more embodiments, the amount of deformed ferrite, when present, can vary from about 10% to about 50% of the ferrite structure.

End Uses

As mentioned above, the steel is particularly useful as a precursor for making linepipe. The steel can also be used for offshore structures including risers, oil and gas production facilities, chemicals production facilities, ship building, automotive manufacturing, airplane manufacturing, and power generation. One specific use is for pressure vessels.

During linepipe fabrication, the precursor steel plate is first bent by a mill press into a “U” shape and then bent further into an “O” shape. At this stage, the pipe is seam welded. The oval shaped pipe is then deformed into a finished round cylinder. This pipe making process is known as the “UOE” process and is the most commonly used technique for manufacturing high strength linepipe.

### EXAMPLES

The foregoing discussion can be further described with reference to the following non-limiting examples.

Twelve steel precursors (Examples 1-12) were prepared from heats having the chemical compositions shown in Table I. Each precursor was prepared by vacuum induction melting 300 kg heats and casting into billets or by using a 300 ton industrial basic oxygen furnace and continuously casting into steel slabs. The billets were prepared according to the particular process conditions summarized in Table II. Certain steel plates were prepared from the steel precursors of Table I. Table III reports the final thickness and mechanical properties of those steel plates. In the tables, a dash means that no data are available.

TABLE I
Chemical Compositions (wt. %)

| EX. | C | Si | Mn | P* | S* | Ni | Cu | Cr | Mo | V | Nb | Ti | Al | N* | B* | Pcm |
|---|---|---|---|---|---|---|---|---|---|---|---|---|---|---|---|---|
| 1 | 0.071 | 0.11 | 1.8 | 80 | 5 | 0.69 | — | — | 0.3 | 0.06 | 0.029 | 0.012 | 0.013 | 27 | 10 | 0.205 |
| 2 | 0.05 | 0.11 | 1.8 | 80 | 4 | 0.7 | — | — | 0.41 | 0.06 | 0.03 | 0.012 | 0.012 | 31 | 10 | 0.192 |
| 3 | 0.04 | 0.1 | 1.95 | | | 0.8 | 0.8 | 0.8 | 0.45 | 0.06 | 0.02 | — | — | — | 10 | 0.273 |
| 4 | 0.06 | 0.12 | 1.59 | 80 | 5 | 0.51 | — | — | 0.3 | 0.06 | 0.031 | 0.012 | 0.011 | 34 | 11 | 0.182 |
| 5 | 0.05 | 0.07 | 1.79 | 60 | 10 | 0.35 | — | 0.6 | 0.3 | 0.03 | 0.03 | 0.012 | 0.021 | 19 | — | 0.200 |
| 6 | 0.049 | 0.07 | 1.79 | 60 | 8 | 0.35 | — | 0.6 | 0.3 | 0.059 | 0.031 | 0.012 | 0.019 | 19 | — | 0.201 |
| 7 | 0.071 | 0.07 | 1.79 | 60 | 8 | 0.35 | — | 0.6 | 0.3 | 0.059 | 0.03 | 0.012 | 0.019 | 21 | — | 0.223 |
| 8 | 0.072 | 0.25 | 1.97 | 80 | 16 | 0.33 | 0.4 | 0.6 | 0.46 | 0.052 | 0.032 | 0.015 | 0.018 | 40 | — | 0.268 |
| 9 | 0.049 | 0.07 | 1.62 | 50 | 6 | 0.35 | — | — | 0.2 | 0.06 | 0.03 | 0.015 | 0.02 | 27 | 9 | 0.160 |
| 10 | 0.049 | 0.07 | 1.8 | 50 | 8 | 0.35 | — | — | 0.2 | 0.06 | 0.03 | 0.015 | 0.02 | 25 | 8 | 0.169 |
| 11 | 0.049 | 0.07 | 1.81 | 50 | 7 | 0.35 | — | — | 0.2 | 0.062 | 0.032 | 0.018 | 0.02 | 31 | 9 | 0.170 |
| 12 | 0.07 | 0.09 | 1.94 | 50 | 10 | 0.35 | — | 0.3 | 0.3 | 0.059 | 0.031 | 0.014 | 0.02 | 16 | 9 | 0.219 |

*ppm

TABLE II
Processing Conditions

| | Reheat | Finish | | | | |
|---|---|---|---|---|---|---|
| | Temp-time | rolling (° C.) | | Water cooling (° C.) | | |
| | (° C.- | Start | Finish | Processing | Start | Finish |
| Process | minute) | Temp | Temp | Type | Temp | Temp |
| A | 1150-180 | 850 | 778 | DLQ | 650 | RT |
| B | 1150-180 | 850 | 771 | DLQ | 565 | 250 |
| C | 1150-180 | 850 | 692 | DPP + DLQ | 626 | RT |
| D | 1150-180 | 850 | 780 | DLQ | 520 | RT |
| E | 1150-180 | 850 | 700 | DPP + DLQ | 600 | RT |
| F | 1150-180 | 850 | 699 | DPP + DLQ | 580 | RT |
| G | 1150-60 | 770 | 730 | DPP | — | RT |
| H | 1150-60 | 850 | 714 | DPP | — | RT |
| I | 1150-60 | 885 | 826 | DLQ | 651 | RT |

TABLE III
Mechanical properties of steel precursors.

| | | Plate | | | Tensile Properties | | | | | Charpy | |
|---|---|---|---|---|---|---|---|---|---|---|---|
| | | Thickness | Ferrite | Test | YS | TS | | | | vE-40° C. | vTrs |
| EX. | Process | (mm) | vol % | Direction | (MPa) | (MPa) | UEL % | EL % | YR % | avg. (J) | (° C.) |
| 1 | A | 16 | — | T | 1055 | 1198 | 3.3 | 22 | 88 | 257 | −100 |
| 1 | B | 16 | — | T | 955 | 1141 | 4.2 | 23 | 84 | 223 | −80 |
| 1 | C | 16 | — | T | 884 | 1054 | 4.2 | 23 | 84 | 247 | −80 |
| 1 | F | 16 | — | L | 912 | 1125 | 5.1 | 25 | 81 | 284 | −90 |
| 2 | A | 16 | — | T | 941 | 1085 | 3.8 | 23 | 87 | 306 | −100 |
| 2 | A | 16 | — | T | 851 | 1037 | 4.1 | 24 | 82 | 269 | −100 |
| 2 | B | 16 | 30 | L | 811 | 1037* | 5.2 | — | 79 | 269 | — |
| 2 | C | 16 | 25 | L | 752 | 1001* | 5.5 | — | 70 | 321 | — |
| 2 | C | 16 | — | T | 835 | 1001 | 4.7 | 26 | 83 | 321 | <−100 |
| 2 | D | 16 | — | L | 651 | 876 | 5.4 | 28 | 74 | 313 | −90 |
| 2 | E | 16 | — | L | 768 | 989 | 5.4 | 27 | 78 | 356 | <−100 |
| 3 | A | 16 | — | T | 914 | 1052 | 3 | 24 | 87 | 294 | <−100 |
| 3 | B | 16 | — | T | 935 | 1071 | 3.1 | 24 | 87 | 286 | <−100 |
| 3 | C | 16 | — | T | 885 | 1040 | 3.7 | 25 | 85 | 292 | <−100 |
| 4 | B | 16 | — | L | 721 | 943 | 5.4 | 29 | 76 | 281 | −80 |
| 4 | C | 16 | — | L | 708 | 939 | 6.3 | 30 | 75 | 345 | <−100 |
| 4 | E | 16 | — | L | 693 | 939 | 6.3 | 29 | 74 | 365 | <−100 |
| 4 | E | 16 | 40 | L | 693 | 979* | 6.3 | 29 | 74 | 365 | <−100 |
| 5 | G | 20 | — | L | 604 | 815 | — | 37 | 74 | 349 | <−120 |
| 6 | G | 20 | — | L | 626 | 843 | — | 38 | 74 | 344 | −118 |
| 7 | G | 20 | — | L | 690 | 972 | — | 33 | 71 | 268 | −115 |
| 8 | H | 20 | — | T | 928 | 1219 | — | 24 | 76 | 164 | −105 |
| 9 | I | 20 | — | L | 567 | 775 | — | 36 | 73 | 351 | −106 |
| 10 | I | 20 | — | L | 629 | 854 | — | 35 | 74 | 354 | −97 |
| 11 | I | 20 | — | L | 689 | 995 | — | 33 | 69 | 304 | −81 |
| 12 | I | 20 | — | L | 845 | 1138 | — | 29 | 75 | 253 | −93 |

*measured in the transverse direction

The mechanical properties reported in Table III were measured according to standard procedures well known in the art. The microstructures of certain examples reported in Table III were characterized using SEM and TEM techniques. The regions investigated were near surface, quarter-thickness and mid-thickness locations. Analysis focused on phase and constituent identification and on quantification of the ferrite volume fraction.

The ferrite phase volume fraction was quantified by image analysis using a combination of SEM and TEM images from quarter-thickness regions. The SEM images had a magnification of 1000× and 3000×, and the TEM images had a magnification of 17,000×. Since there is some ambiguity in the SEM analyses of ferrite phase due to its fine scale structure and distribution, TEM was the critical technique used to assess ferrite volume fraction. As compared to the other phases in the steels, ferrite can be readily identified in the TEM by its relatively clean appearance, granular structure with comparatively very low number of dislocations. Therefore, a set of 10 TEM images were obtained from adjacent regions of the thin foil specimen of the steel examined and these images were used to calculate the average area fraction of ferrite. Not wishing to be bound by theory, this average area fraction is believed to represent the volume fraction of ferrite in the steel. The ferrite volume fraction from the quarter thickness location is reported in Table III.

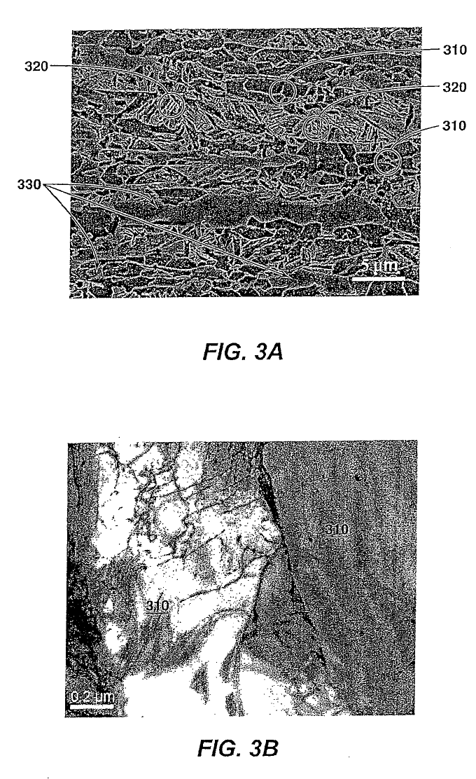

FIG. 3A is a scanning electron microscope (SEM) micrograph showing the composite micrograph of Example 4 made according to process E. FIG. 3B is a transmission electron microscope (TEM) micrograph showing the ferrite domains shown in FIG. 3A. These micrographs represent the fine, uniform distribution of the microstructural constituents in the dual phase steel processed according to embodiments described. Certain ones of the ferrite domains 310, degenerate upper bainite (DUB) domains 320, and lath martensite (LM) domains 330 are identified in FIG. 3A. As shown in FIG. 3B, the fine, ferrite domains 310 were less than about one micron in width.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A high strength, dual phase steel with a tensile strength of about 900 MPa or more, a low yield ratio of about 0.85 or less in a longitudinal direction, and a Charpy-V-Notch toughness at −40° C. exceeding about 120 J or more in the transverse direction, comprising:
carbon in an amount from about 0.03% by weight to about 0.12 wt %;
nickel in an amount of about 0.1 wt % to less than 1.0 wt %;
niobium in an amount of about 0.005 wt % to about 0.05 wt %;
titanium in an amount of about 0.005 wt % to about 0.03 wt %;
molybdenum in an amount of about 0.1 wt % to about 0.6 wt %; and
manganese in an amount of about 0.5 wt % to about 2.5 wt %;
a first phase consisting essentially of fine-grained ferrite, wherein the steel comprises from about 10% by volume to about 60% by volume of the first phase, and the first phase comprises a ferrite mean grain size of about 5 microns or less; and
a second phase comprising: fine-grained martensite, fine-grained lower bainite, fine-grained granular bainite, fine-grained degenerate upper bainite, or any mixture thereof, wherein the steel comprises from about 40% by volume to about 90% by volume of the second phase.

2. The steel of claim 1, wherein the steel further comprises copper in an amount of about 1.0 wt % or less.

3. The steel of claim 1, wherein the steel further comprises chromium in an amount of about 1.0 wt % or less.

4. The steel of claim 1, wherein the steel further comprises calcium in an amount of about 0.01 wt % or less.

5. The steel of claim 1, wherein the first phase comprises less than about 50% by volume of worked ferrite.

6. The steel of claim 1, wherein the dual phase steel is a precursor for a steel plate having a thickness of about 10 mm to about 25 mm.

7. The steel of claim 1, further comprising the following optional elements, by weight:
up to about 0.1% vanadium;
up to about 0.002% boron;
up to about 1.0% chromium;
up to about 0.006% magnesium;
up to about 0.010% nitrogen;
up to about 0.5% silicon;
up to about 1.0% copper;
up to about 0.06% aluminum;
up to about 0.015% phosphorus; and
up to about 0.004% sulfur.

8. A method for preparing a steel plate with a tensile strength of about 900 MPa or more, a low yield ratio of about 0.85 or less in a longitudinal direction, and a Charpy-V-Notch toughness at −40° C. exceeding about 120 J or more in the transverse direction, comprising:
heating a steel slab to a reheating temperature from about 1,000° C. to about 1,250° C. to provide a steel slab consisting essentially of an austenite phase;
reducing the steel slab to form the steel plate in one or more hot rolling passes at a first temperature sufficient to recrystallize the austenite phase;
reducing the steel plate in one or more hot rolling passes at a second temperature range below the first temperature at a temperature where austenite does not recrystallize and above Ar3 transformation temperature;
cooling the steel plate in ambient air to a temperature above about 500° C.; and
quenching the steel plate at a cooling rate of at least 10° C. per second (18° F./sec) to a pre-selected quench stop temperature.

9. The steel plate of claim 8, wherein in the cooling in ambient air step, the steel plate is cooled to a temperature between about 500° C. and about 650° C.

10. The steel plate of claim 8, wherein the steel plate comprises a ferrite mean grain size of about 5 microns or less.

11. The steel plate of claim 8, wherein the steel plate comprises a prior austenite grain size of about 10 microns or less.

12. The steel plate of claim 8, wherein the pre-selected quench stop temperature is between about 400° C. and about room temperature.

13. The steel plate of claim 8, wherein the pre-selected quench stop temperature is between about 200° C. and about 400° C.

14. A steel plate with a tensile strength of about 900 MPa or more, a low yield ratio of about 0.85 or less in a longitudinal direction, and a Charpy-V-Notch toughness at −40° C. exceeding about 120 J or more in the transverse direction, comprising from about 10% by volume to about 60% by volume of a first phase consisting essentially of fine grained ferrite, from about 40% by volume to about 90% by volume of a second phase comprising fine-grained martensite, fine-grained lower bainite, fine-grained granular bainite, fine-grained degenerate upper bainite, or any mixture thereof, produced by a method comprising the steps of:
heating a steel slab to a reheating temperature from about 1,000° C. to about 1,250° C. to provide a steel slab consisting essentially of an austinite phase;
reducing the steel slab to form the steel plate in one or more hot rolling passes at a first temperature sufficient to recrystallize the austenite phase;
reducing the steel plate in one or more hot rolling passes at a second temperature range below the first temperature wherein the austenite phase does not recrystallize and above Ar3 transformation temperature;
further reducing the steel plate in one or more hot rolling passes at a third temperature range between about the Ar3 transformation temperature and about Ar1 transformation temperature; and
quenching the steel plate at a cooling rate of at least 10° C. per second (18° F./sec) to a pre-selected quench stop temperature.

15. The steel plate of claim 14, wherein the pre-selected quench stop temperature is between about 400° C. and about room temperature.

16. The steel plate of claim 14, further comprising cooling the steel plate in ambient air after the hot rolling steps to a temperature no less than about 500° C. prior to quenching the steel plate to the pre-selected quench stop temperature.

17. The steel plate of claim 16, wherein in the cooling in ambient air step, the steel plate is cooled to a temperature between about 500° C. and about 650° C. prior to quenching the steel plate to the pre-selected quench stop temperature.

18. The steel plate of claim 14, wherein the steel plate comprises a ferrite mean grain size of about 5 microns or less and a prior austenite grain size of about 10 microns or less.

19. The steel plate of claim 14, further comprising forming the steel plate into pipe.

20. The steel plate of claim 14, further comprising forming the steel plate into line pipe using an UOE technique.
